(19) United States
(12) Patent Application Publication
(10) Pub. No.: US 2011/0093448 A1
(43) Pub. Date: Apr. 21, 2011

(54) SYSTEM METHOD AND COMPUTER PROGRAM PRODUCT FOR PEDIGREE ANALYSIS

(75) Inventors: Shaik Rafi, Nellore (IN); Neenka Dimitrova, Pelham Manor, NY (US)

(73) Assignee: Koninklijke Philips Electronics N.V., Eindhoven (NL)

(21) Appl. No.: 12/997,642

(22) PCT Filed: Jun. 15, 2009
(86) PCT No.: PCT/IB2009/052536

§ 371 Date: Dec. 13, 2010

(30) Foreign Application Priority Data
Jun. 20, 2008 (EP) 08158650.5

(51) Int. Cl. G06F 17/30

(52) U.S. Cl. 707/708; 707/E17.014

(57) ABSTRACT

This invention pertains in general to the field of data mining. More particularly the invention relates to a system (10) for displaying genetic information. Said system comprises a server (11) and a database (12), wherein said database (12) comprises data storage unit adapted for mass-scale storage of family genetic history records.

### FIELD OF THE INVENTION

This invention pertains in general to the field of data mining. More particularly the invention relates to handling, analyzing and displaying genetic information.

### BACKGROUND OF THE INVENTION

Polygenic traits like height, skin color and disorders like diabetes, obesity, cancer etc. involve many genes and multiple environmental factors. Also, complex interactions between these genes and environmental factors interact to produce a particular phenotype. Monogenic disorders are not as complex as polygenic disorders, but show huge variations in their distribution because of unapparent reasons, i.e. prevalence of sickle cell trait or beta thalassemia in areas where malaria is common.

Tracking both monogenic and polygenic histories through generations of related individuals is an important component of genetic research and medical counseling. Information may be collected about the disease history of a person and the person's relatives and then analyzed to calculate the familial risk of common disorders such as coronary heart disease, stroke, type II diabetes and different forms of cancer. The calculated risk may then be used to determine recommendations for managing, preventing and screening for the disorder.

The abovementioned calculations are usually performed by geneticists or with the help of simple computer software. Traditional pedigree analysis may also be used for predicting the chance of recurrence of a disease trait (mostly monogenic) in the progeny, if their parents carry that trait. However, current software tools only provide drawing of a pedigree and views for one specific disorder, some provide risk calculations based on pedigree information for complex disorders like cancer and some provide statistics for monogenic disorders.

Thus, there is a need for an improved information handling system, method, and computer program product allowing for increased flexibility, capacity and/or cost-effectiveness.

Accordingly, the present invention preferably seeks to mitigate, alleviate or eliminate one or more of the above-identified deficiencies in the art and disadvantages singly or in any combination and solves at least the above-mentioned problems by providing a system, a method, and computer program product according to the appended claims.

According to one aspect of the invention a pedigree analysis information system is provided. The system may comprise a server. Moreover, the system may comprise a database associated with the server, wherein the database comprises data storage unit adapted for mass-scale storage of family genetic history records, each family genetic history record containing data on one or more traits and/or disorders stored in accordance with a data structure which classifies genetic traits. Furthermore, the server may comprise a query unit for accepting from a remote user a query containing at least one trait or disorder of interest. The server may also comprise an analysis unit for analyzing the family genetic history records of the database so as to identify relationship(s) between the at least one trait or disorder of interest and one or more other traits or disorders. The server may also comprise a report unit for providing to the remote user a report containing any relationship(s) identified by the analysis unit.

According to another aspect of the invention a method for pedigree analysis is provided. The method may comprise receiving a query from a user. The query comprises at least one trait or disorder of interest. The query may be processed, i.e. by analyzing family genetic history records of a database. The database may comprise a data structure, which may be based on classification of genetic traits. The family genetic history records may comprise data of one or more traits and/or disorders. This may result in information of relationship(s) between the at least one trait or disorder of interest and one or more other traits or disorders. The method for pedigree analysis may also create a report comprising the information of relationship(s).

According one embodiment, the method may be performed by a computer program product. The computer program product may comprise code segments arranged, when run by an apparatus having computer-processing properties, for performing all of the method steps.

An advantage of the present invention according to some embodiments is that it is adapted to enable handling of information from a number of users, such as potentially users of the Internet. This may provide more accurate predictions of e.g. familial risk of common disorders such as coronary heart disease, stroke, type II diabetes and different forms of cancer. The results obtained from the invention according to some embodiments also provide tailor-made, purpose-driven output options as well as allowing users to add new traits to which users subsequently may query and add data.

A further advantage of the invention according to some embodiments is that a user using the system may investigate his disorder or trait at a personnel level and better understand it with different questions of his/her interest and also know how to manage the trait based on the personnel summary and helpful resources provided. This may in turn make the user feel more secure.

### BRIEF DESCRIPTION OF THE DRAWINGS

These and other aspects, features and advantages of which the invention is capable of will be apparent and elucidated from the following description of embodiments of the present invention, reference being made to the accompanying drawings, in which

FIG. 1 is a schematic illustration of a pedigree information analysis system;

FIG. 2 is a flowchart showing an example of the genetic traits data structure (GTDS);

FIG. 3 is a flowchart showing an example of an entity-relationship diagram (ER diagram) related to the database 12;

FIG. 4 is a flowchart showing an example of PIMS representing the user work flows, various entry points into the system and the output generated;

FIG. 5 is a flowchart showing a more specific example of how to navigate through PIMS;

FIG. 6 is a sample of an anonymous pedigree; and

FIG. 7 is a sample of a question specific pedigree.

### DETAILED DESCRIPTION OF EMBODIMENTS

Several embodiments of the present invention will be described in more detail below with reference to the accompanying drawings in order for those skilled in the art to be able to carry out the invention. The invention may, however, be embodied in many different forms and should not be construed as limited to the embodiments set forth herein. Rather, these embodiments are provided so that this disclosure will be thorough and complete, and will fully convey the scope of the invention to those skilled in the art. The embodiments do not limit the invention, but the invention is only limited by the appended patent claims. Furthermore, the terminology used in the detailed description of the particular embodiments illustrated in the accompanying drawings is not intended to be limiting of the invention.

The following description focuses on embodiments of the present invention applicable to a genetic information system and in particular to a pedigree information mining system (PIMS). This system may be an online system to store familial genetic information, compare and analyze with similar pedigrees for specific disorders or traits. The genetic traits take the centre stage in the whole system, as those are the ones addressed with the information mined from family data. However, it will be appreciated that the invention is not limited to this application but may be applied to many other information mining systems including for example genealogy and matchmaking

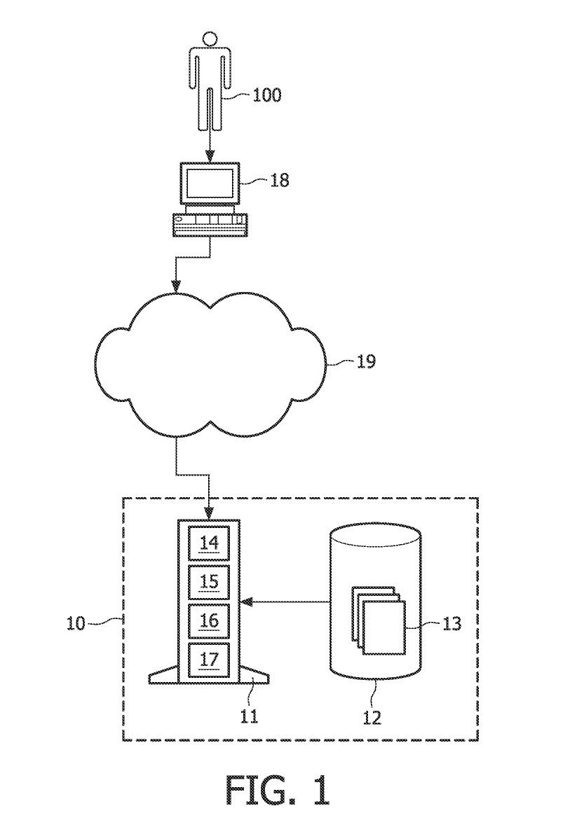

In an embodiment, according to FIG. 1, a pedigree analysis information system 10 is provided. The system comprises a server 11 and a database 12 associated with the server 11. The database 12 may comprise a statistics registry based on family genetic histories and a querying interface for genetic disorders and traits. The server 11 may be configured to provide trait specific pedigrees for any genetic trait of interest using a genetic traits data structure to classify genetic traits. The server 11 may also be configured to draw pedigrees. Moreover the server 11 may be configured to make predictions based on information in the database 12 for known genetic traits. Moreover, the server 11 may be configured to make predictions based on information of the database 12 for any familial character. The server 11 may also be configured to document individual family health and genetic information at a mass scale. For example, the query means 14, the analysis means 15 and the report means 16 of the server 11 may be configured to process a specific query and generate a desired output. This comprise handling parameters to be used in the processing. A user 100 may influence the configuration of the system 10. According to one embodiment, the user 100 is the PIMS management personnel. According to another embodiment, the user 100 is the question creator.

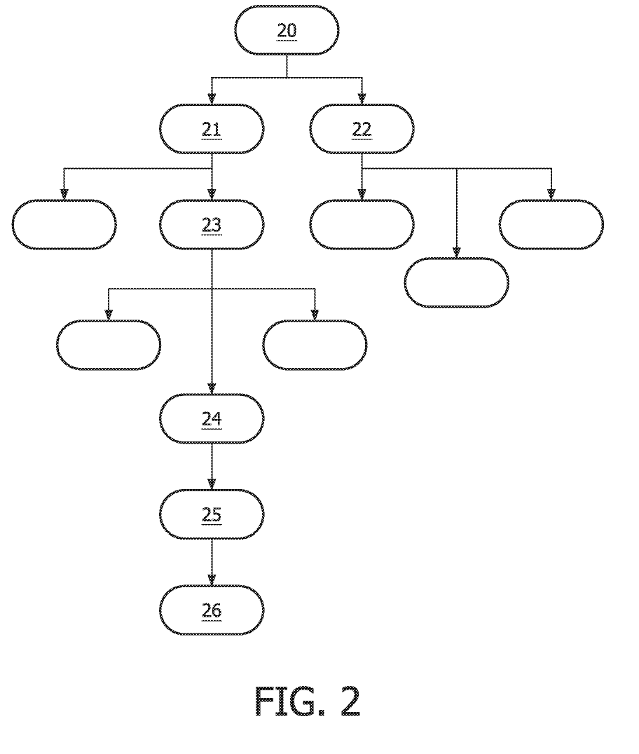

In an embodiment according to FIG. 2, a Genetic traits data structure (GTDS) is provided. GTDS may be used for classification of genetic traits and related questions in the database 12. A numbering system may be used to identify each trait, and question by a unique GTDS number. For example, each trait may be given a unique number from which the complete data structure of the trait can be deduced. The number may also be used for quicker identification and processing.

The structure comprises genetic traits 20 as root, which means that genetic traits is the parent node for the whole GTDS, and two basic nodes, which are the child nodes of the parent node as shown in FIG. 2, classifying the traits as health care traits 21 and life style traits 22. Examples of health care traits 21 are polygenic traits and monogenic traits 23. Examples of life style traits 22 are behavioral traits, psychological traits and miscellaneous traits. Furthermore, examples of monogenic traits 23 are X-linked, Autosomal 24 and P-linked traits. The hierarchy and data structure of GTDS may be hidden in Java programs and may be referred to generate a GTDS number for new queries. Furthermore, FIG. 2 shows an example data structure for sickle cell disease 25, which is an autosomal disease 24, which in turn is a monogenic trait 23. A suitable numbering system is used to identify the sickle cell disease 25 and a specific question like sickle cell disease in combination with malaria 26. As new queries are added to the system, the system management are revising and expanding GTDS to group similar queries to make more specific substructures. Thus, GTDS is not fixed, but grows dynamically. It keeps expanding and evolving, which provides flexibility and ease of use compared to the existing data structures.

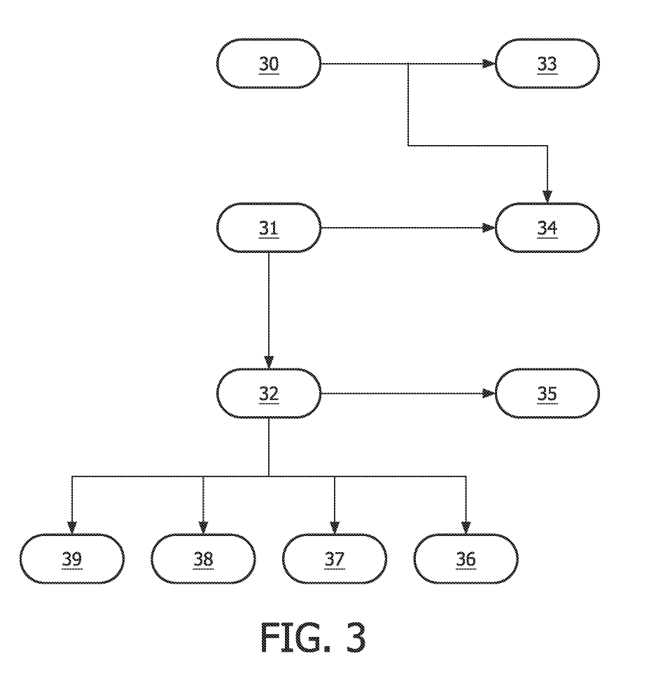

A further embodiment is illustrated in FIG. 3. In this case, the database 12 comprises three main entities, which may be called tables: user 30, trait question 31 and disease 32. The user entity 30 is a table to store the basic details about every user, e.g. Account ID (A.ID), user name and/or address. It will also store the Question Ids (Q.ID) of the various questions attended. The family info entity 33 may contain the basic information like relationship, name, age etc about every family member of the account holder. The member may be identified by a member ID (M.ID), which may also be contained in the family info entity 33. Using A.ID and relationships the basic pedigree for every account holder would be drawn by a Java module. The family info entity 33 may also be used to store other information about members to make it more comprehensive like pictures, audio, video, mails related to each family member.

The trait question table 31 may store the details such as a unique GTDS number to identify itself in the data structure, question name, which may be a sentence or word, the key word related to a question, like presence or absence of a disease or trait, other related words and information like creator A.ID, creation date etc. Family info for traits table 34 may store the information about specific question key and other words for a specific member identified by Q.ID and family ID (F.ID). The family info for traits table 34 may cross-refer with the trait question table 31 to get key word and related word for a specific question. The information from three tables, Trait question 31, Family info 33 and Family info for traits 34, may be combined to generate a pedigree specific for the question for a particular user 100.

For queries related to genetic disease, information may be provided at various levels and from diverse sources. The disease table 32 may store information about the disease prevalence, aetiology and may also have connections to further tables like a diagnosis table 35, that may tell about tests available, type of sample required (e.g. blood, tissue, urine) and sensitivity of the test, a treatment table 36, that may store information like treatment centre locations, efficacy of the treatment, cost and so on, a clinical expert table 37, that may be an entity providing information about various experts for the disease available their location and experience etc, a genes table 38, that may store the gene IDs related to the disorder, their properties, such as mutations aberrant gene expression, and differential methylation status correlated with a particular disease, and a publications table 39, that may store information like PMIDs, title, abstract etc. and links to external databases, such as GeneReviews, OMIM and PubMed. PIMS may retrieve information from these tables to generate the summary and statistics for the trait questions related to diseases.

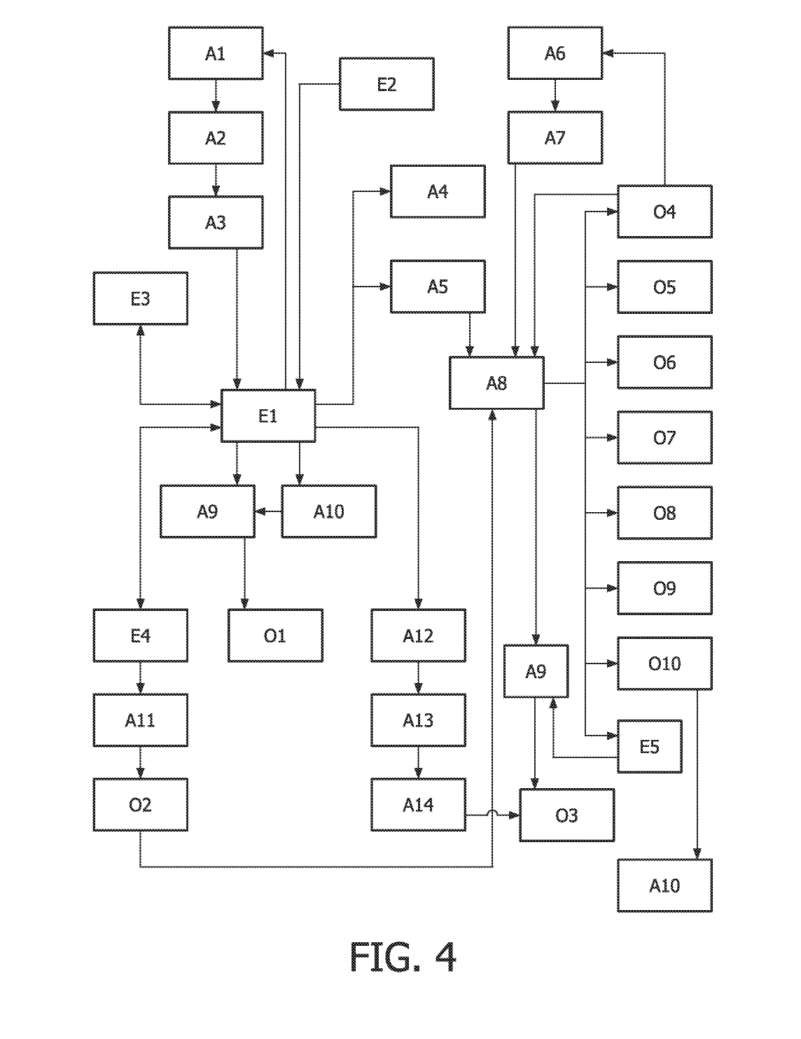

In another embodiment according to FIG. 4, a flowchart of PIMS representing the user work flows is disclosed. Various entry points (E) into the system and the output (O) generated are shown. Different actions (A) are also shown. Entry points may be for example user login E1; browsing PIMS E2; add a new question E3; searching PIMS E4; add your pedigree info for this question E5. Output may for be example generate and save basic pedigree O1; search result (list of related queries) O2; submit for authentication O3; related questions O4; representative pedigree (anonymous/specific) O5; DB stats for question O6; PIMS summary O7; links to resources O8; data structure of question O9; discussion board O10. Actions may be for example new user A1; A/C info A2; A/C created A3; basic pedigree A4; question attended A5; view info for a member A6; all questions with info on member A7; select a specific question A8; enter member info for specific question A9; add new message A10.

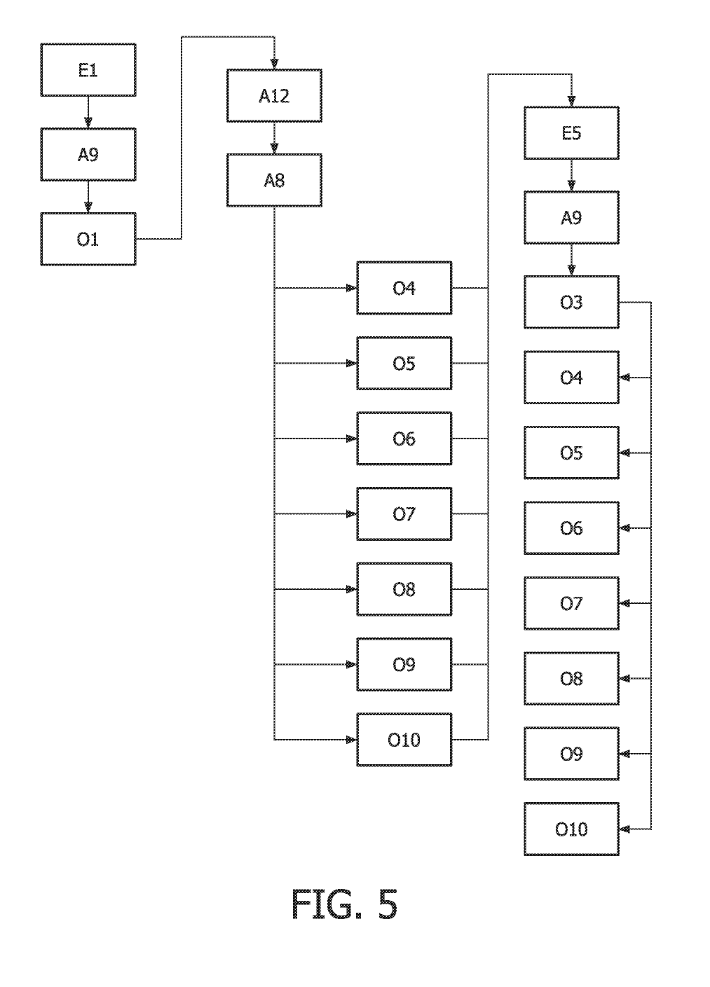

In an embodiment according to FIG. 5, an example of a specific workflow for moving through the flowchart according to claim 4 is provided. A new user 100 may enter the system by creating an account/login A1; adding his/her family details A9; and generate and save a simple pedigree O1. Then the user 100 may brows through the data structure A12 of the GTDS to select a specific question A8; after that, the user 100 may view the anonymous pedigree O5, PIMS summary O7 and so on as shown in boxes O4, O6, O8, O9 and O10. Then the user 100 may enter his/her family details E5 for that specific question to generate his/her pedigree for that particular question A9, submit for authentication O3 and get any of the outputs O4 to O10.

In another embodiment, the system 10 comprises an edit unit 17. The edit unit is configured to allow a user 100, to input one or more new question(s). The edit unit is configured to allow another user 100 i.e. the PIMS maintenance personnel, to study each new question. The edit unit is configured to allow the first user 100 to be informed if the question is added to the system. For example, the user 100 may start by selecting the section “Add new questions” and traverse through the hierarchy of GTDS and select an appropriate category to add a new question. The question could be a sentence or a collection of words that would be applied to every family members and information related to them registered. The creator could specify the output format while there would be a standard output format for all questions like related questions, summary on the question etc. Finally the creator enters information about his family to make the first record.

According to one embodiment, the system 10 is configured to retrieve all questions of interest. Clicking on any question shows its hierarchy, general summary of the question and an example anonymous pedigree. The user 100 may add his family data for that question and get a personal prediction.

According to another embodiment, the system 10 is configured to provide a discussion board with each question to discuss opinion of the user 100 and visitors on that trait, question and PIMS results.

According to one further embodiment, the system 10 is configured to report to the user 100 about growth of PIMS, New traits and questions added to the system, questions attended by highest number of users and so on through a PIMS newsletter.

According to one embodiment, the system 10 is configured so that the report unit 16 provides a health information record sheet. With PIMS, a user 100 may record any kind of health problems like fever, headache with date the user 100 had the ailment along with the doctor visited, time to recover and so on. This would be helpful as a health record for a user 100 to check how healthy he has been and also assess the quality of life he is leading. As the system 10 may be configured to store the basic health and trait related details of a user 100 and his family, it may also be providing a space to record his and his family health status for tracking and to see how their lifestyles are influencing their health.

In a further embodiment, to the system 10 is configured so that the analysis unit 15 look for closer pedigrees based on surname, location and so forth. The details of a user 100 would be provided based only on prior permission from the party. Also the U.ID of the closer pedigrees would be stored to help the user 100.

In yet another embodiment, the system 10 is configured so that the report unit 16 displays pedigrees and the related information in different languages; it would be helpful for the family members who know only the local language.

According to one embodiment, the user 100 of the system 10 is a clinician or a geneticist. The system 10 is configured so that the report unit 16 provide the user 100 with inheritance pattern of a genetic disorder in a given population represented by an anonymous pedigree, database statistics for the disorder, general summary, related resources and advanced querying options to understand related facts like quality of life, other disorders in that population and so on.

According to another embodiment, the user 100 of the system 10 is a patient who queries a patient specific pedigree for his/her disorder. The system 10 is configured so that the report unit 16 provides tailor made database statistics and a summary that includes general behavior of the related pedigrees for the disorder, patient specific management options and advanced querying options.

According to yet another embodiment, the system 10 is configured so that the report unit 16 provides a user 100, who is generally interested in health related queries, with information about a specific disease, genes involved, diagnostic and treatment options, links to useful resources and clinical experts for the disease.

According to a further embodiment, the system 10 is configured so that the report unit 16 provides the user 100, who is a researcher able to query the system 10, information on various traits on both health care and lifestyle traits, add specific questions for traits and also would be able to get all the general information related to the trait as explained above.

According to one embodiment, the disease homocystinuria is considered. Homocystinuria is a metabolic disorder leading to increased secretion of the amino acid homocysteine in the urine. The disorder exists both in acquired and inherited form. When a user 100 queries the system 10, the following information may be provided from the database 12:

the total number of patients with homocystinuria in the system;

the total number of Pedigrees with homocystinuria (with more than one patient);

the number of patients with homocystinuria having/had folic acid treatment;

the total number of Indian pedigrees with homocystinuria in the system (with more than one patient);

the number of Indian patients with homocystinuria having/had folic acid treatment;

the average Mortality age of homocystinuriacs without folic acid treatment in India;

the average Mortality age of homocystinuriacs with folic acid treatment in India with more than one member in a family;

the quality of life of homocystinuriacs without folic acid treatment in India;

the quality of life of homocystinuriacs with folic acid treatment in India with more than one member in a family;

the number of homocystinuriacs having other serious diseases/disorders;

the number of Indian homocystinuriacs having other serious diseases/disorders; and/or

the number of Indian homocystinuriac pedigrees having other serious diseases/disorders.

The statistical calculations may be performed in a trait specific manner i.e. whenever new pedigree information is added for a trait. The statistics of the trait may also be recalculated and updated, and presented when a user based on user input request such information.

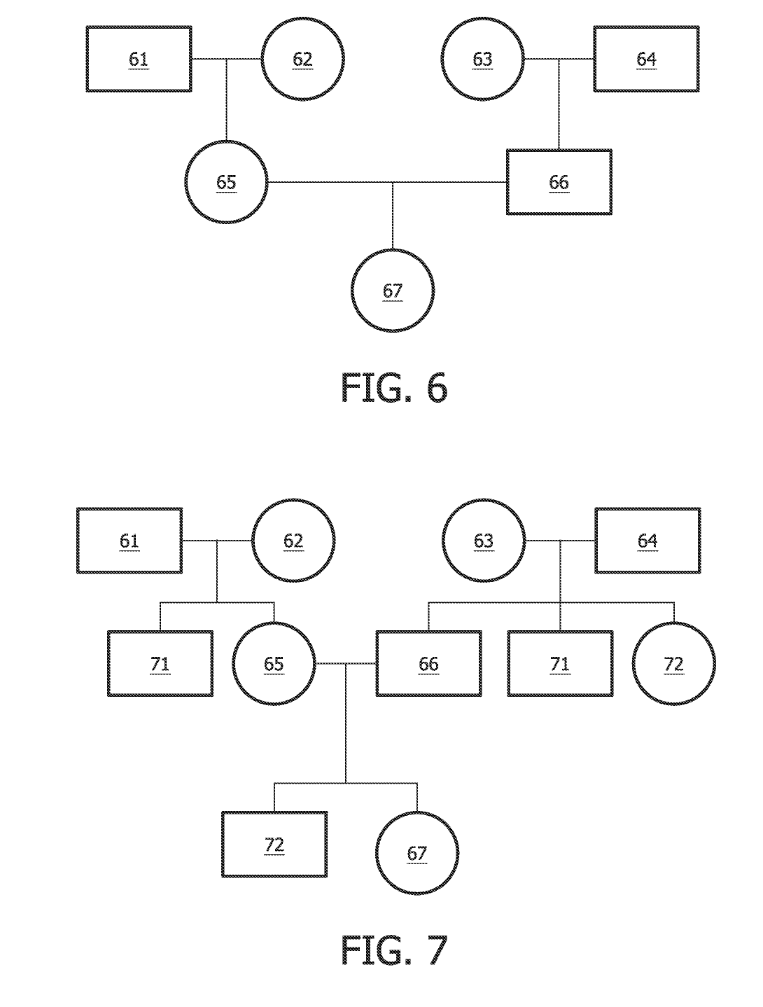

For example, if a user 100 who already has an account and a simple pedigree with the system selects a question “Effect of folic acid treatment for homocystinuriacs in India”, the system according to some embodiments is configured to display a an anonymous pedigree as shown. FIG. 6 illustrates such an anonymous pedigree, wherein the squared symbols represent males and the circular symbols represent females. Each row of symbols is a generation. 61 designates mother's mother, 62 designates mother's father, 63 designates father's mother, 64 designates father's father, 65 designates mother, 66 designates father and 67 designates user 100. The symbols may be partly or totally filled marking the percentage of members in the questions specific pedigree who had an effective treatment with folic acid for Homocystinuria. This percentage may also be shown in figures in connection with each symbol.

The anonymous pedigree may act as a representative pedigree for the question, based on the available information in the system. The user 100 may move his/her mouse marker over any of the family members to show the details, e.g. number of users who are homocystinuriacs for whom the folic acid treatment was found to be effective, number of mothers mother's who were homocystinuriacs for whom the folic acid treatment was found to be effective, number of mothers mother's who were homocystinuriacs and had an affected user, other ailments the mothers mother's commonly had and so on. The accompanying report with the anonymous pedigree may give a whole lot of information, like number of pedigrees for the question in the system; location for the highest numbers of pedigrees with most common surname, Average BMI of the user, Average mortality rate, Quality of life, management that was found to be effective for each of the member, recommended lifestyle changes, drug(s) most commonly used.

According to some embodiments, after viewing the anonymous pedigree and details, the system may provide the user 100 with a question specific pedigree for his/her family. The user may then add his/her family and other required details such as the members who are homocystinuriacs, who had folic acid treatment, management, quality of life of each of the member and so on. The basic details like BMI, mortality rate, surname, location etc that are entered for generating a simple pedigree stored in family info table. This may also be used to generate prediction score and other results.

FIG. 7 illustrates a question specific pedigree for the user 100. The squared symbols in FIG. 7 represent males and the circular symbols represent females. Each row of symbols is a generation. 61 designates mother's mother, 62 designates mother's father, 63 designates father's mother, 64 designates father's father, 65 designates mother, 71 designates uncle, 66 designates father, 72 designates aunt, 72 designates brother and 67 designates user 100.

If a family member is affected with Homocystinuria, the system may be configured to visualize this fact using a color gradient on the corresponding symbol. If a member has had an effective treatment with folic acid, a different color gradient may be used for the corresponding symbol. If a member both has had Homocystinuria and has had an effective treatment, two colors may be used in the same symbol.

Details related to the question, specific to the user such as quality of life of uncles who are homocystinuriacs and had effective folic acid treatment, average BMI etc. may be shown in a separate window or upon mouse over. The accompanying report with the specific pedigree may give a whole lot of information similar to the anonymous pedigree report but may be tailor made for that pedigree in the sense of ethnic group which would also include lifestyle changes, drugs, management shown to be effective in that group, resources like support groups for that disorders in that area etc.

In one embodiment, a result output for a query on diabetes may be shown, by drawing a pedigree similar to that shown in FIGS. 6 and 7. The symbols used may be colored based on if the person has diabetes. Other common details like BMI, Veg/Non-veg, other major illnesses etc. may be taken from family info table to generate PIMS prediction score. These scores may be displayed along with the pedigree. The scores may be e.g. the number of pedigrees in PIMS with same surname as user 100, to give him/her an idea about how many families in his community also have diabetes, and information like other Major Health problems in affected families in PIMS etc.

According to one embodiment, the score displayed along with the pedigree comprises:

More specifically PIMS prediction score for the user to be diabetic=35%;

No. of affected user pedigrees/All diabetic pedigrees=200/1000;

No. of affected pedigrees with same surname=50;

No. of affected pedigrees with only second generation affected=600;

Other Major Health problems in affected families; Recommended health changes proven to be effective; and

Related queries.

According to another embodiment, a pediatrician in India has a patient with vague symptoms of homocystinuria and a level of total homocystiene in dried blood of 15.5 μmoles/l (which is higher than normal, but lower than the general level in patients suffering from homocystinuria). For example, when the pediatrician queries the system 10 about pedigrees with 15.5 μmoles/l homocystiene levels and the report unit 16 is configured to provide a homocystinuria pedigree for India e.g. indicating that the levels of total homocystiene in India are between 15 and 25 μmoles/l, which is lower than the global average. The homocystinuria pedigree may also comprise information regarding symptoms, morbidity, mortality and quality of life of homocystinuriacs in India.

According to a more specific embodiment, the system 10 is configured to allow the report unit 16 to display information regarding the mutations responsible for the disorder and information about a platform for genetic testing of homocystinuria mutations to the above pediatrician.

According to a further embodiment, the system 10 is configured to allow a user 100, who is a specific service provider, to provide information about a platform for genetic testing.

According to a yet another embodiment, the system 10 is configured such that the report unit 16 also display information about effective management options to improve quality of life of a patient to the above pediatrician.

According to a further embodiment, the system 10 is configured to allow a user 100, who is a service provider, to provide information about management options.

According to one embodiment, the system 10 is configured to identify a user 100 through an account in the system 10, as explained above, and allow the user 100 access to all the functionalities provided by the system 10. The main advantage with this kind of embodiment is that the number of users 100 would be many and would provide lot of information that would be helpful in generating results with diversity.

In one embodiment, the system 10 is configured such that the report provided by the report unit 16 comprises an advertisement. Income from this kind of embodiment is from advertisements and charging links to resources on web on specific queries.

According to another embodiment, the report unit 16 of the system 10 is configured to create a first report if the query comprises information that the user 100 is a registered user, and a second report if the query comprises information that the user 100 is a paying user. The user input may comprise an identification tag, which is required by the unit to enable the user to access the database. The main requirement for this kind of embodiment is to have a database of considerable size.

In yet another embodiment, a user 100 may create an account and access the features partially i.e. a few sections and features made available to all users 100 such as Basic Pedigree, Browsing and searching through sections like Behavioral queries etc. Significant features, such as PIMS, Summary for a specific question, Resources and links related to the question and some sections such as Health related queries, may be accessible only for registered users 100. This kind of system combines the advantages from the above account based and charged based embodiments, like income from advertisements and also paying users 100, and remedies the disadvantages of the database of considerable size. Also income could be made by pay per use kind of access.

The invention may be implemented in any suitable form including hardware, software, firmware or any combination of these. However, preferably, the invention is implemented as computer software running on one or more data processors and/or digital signal processors. The elements and components of an embodiment of the invention may be physically, functionally and logically implemented in any suitable way. Indeed, the functionality may be implemented in a single unit, in a plurality of units or as part of other functional units. As such, the invention may be implemented in a single unit, or may be physically and functionally distributed between different units and processors.

The server unit 11, query unit 14, analysis unit 15, report unit 16 or edit unit 17 may be any unit normally used for performing the involved tasks, e.g. a hardware, such as a processor with a memory. The processor may be any of variety of processors, such as Intel or AMD processors, CPUs, microprocessors, Programmable Intelligent Computer (PIC) microcontrollers, Digital Signal Processors (DSP), etc. However, the scope of the invention is not limited to these specific processors. The memory may be any memory capable of storing information, such as Random Access Memories (RAM) such as, Double Density RAM (DDR, DDR2), Single Density RAM (SDRAM), Static RAM (SRAM), Dynamic RAM (DRAM), Video RAM (VRAM), etc. The memory may also be a FLASH memory such as a USB, Compact Flash, SmartMedia, MMC memory, MemoryStick, SD Card, MiniSD, MicroSD, xD Card, TransFlash, and MicroDrive memory etc. However, the scope of the invention is not limited to these specific memories.

In an embodiment the apparatus comprises units for performing the method according to some embodiments.

In an embodiment the apparatus is comprised in a medical workstation or medical system, such as a Computed Tomography (CT) system, Magnetic Resonance Imaging (MRI) System or Ultrasound Imaging (US) system.

In one embodiment, the system 10 is connected to one or more communication network(s) 19. This/these network(s), may be connected to one or more clients 18 which may be operated by a user 100.

In an embodiment the computer-readable medium comprises code segments arranged, when run by an apparatus having computer-processing properties, for performing all of the method steps defined in some embodiments.

Although the present invention has been described above with reference to specific embodiments, it is not intended to be limited to the specific form set forth herein. Rather, the invention is limited only by the accompanying claims and, other embodiments than the specific above are equally possible within the scope of these appended claims.

In the claims, the term “comprises/comprising” does not exclude the presence of other elements or steps. Furthermore, although individually listed, a plurality of means, elements or method steps may be implemented by e.g. a single unit or processor. Additionally, although individual features may be included in different claims, these may possibly advantageously be combined, and the inclusion in different claims does not imply that a combination of features is not feasible and/or advantageous. In addition, singular references do not exclude a plurality. The terms “a”, “an”, “first”, “second” etc do not preclude a plurality. Reference signs in the claims are provided merely as a clarifying example and shall not be construed as limiting the scope of the claims in any way.

1. A system (10) for pedigree analysis comprising:
a query unit (14) configured to receive a query from a user (100), wherein said query comprises at least one trait or disorder of interest,
an analysis unit (15) configured to process said query by analyzing at least one family genetic history record (13) stored in a database (12), said database (12) comprising a data structure based on classification of genetic traits, wherein each family genetic history record (13) comprises data of at least one trait and/or disorder, resulting in information of relationship(s) between said at least one trait or disorder of interest and at least another trait or disorder; and
a report unit (16) configured to create a report comprising said information of relationship(s).

2. The system according to claim 1, wherein said query unit (14), said analysis unit (15) or said report unit (16) is comprised in a server (11).

3. The system according to claim 1, wherein said database, based on said query, is configured to be updated with information corresponding to said query.

4. The system according to claim 1, wherein said report comprises specific genes responsible for said diseases and/or disorders, available tests to diagnose said diseases and/or disorders, and/or recommended tests to diagnose said diseases and/or disorders.

5. The system according to claim 1, wherein said report comprises an advertisement.

6. The system according to claim 1, wherein said report unit is configured to create a first report if the query comprises information that said user (100) is a registered user, and a second report if the query comprises information that said user (100) is a paying user.

7. A method for pedigree analysis comprising:
receiving a query from a user (100), wherein said query comprises at least one trait or disorder of interest,
processing said query by analyzing family genetic history records of a database, said database comprising a data structure based on classification of genetic traits, wherein each family genetic history record comprises data of one or more traits and/or disorders, resulting in information of relationship(s) between said at least one trait or disorder of interest and one or more other traits or disorders; and
creating a report comprising said information of relationship(s).

8. A computer program product comprising code segments arranged, when run by an apparatus having computer-processing properties, for performing all of the method steps defined in claim 7.
